(19) United States
(12) Patent Application Publication
(10) Pub. No.: US 2019/0076954 A1
(43) Pub. Date: Mar. 14, 2019

(54) RESISTANCE WELDING METHOD AND RESISTANCE WELDING APPARATUS

(71) Applicant: HONDA MOTOR CO., LTD., Tokyo (JP)

(72) Inventors: Shinya Watanabe, Tochigi-ken (JP); Hitoshi Saito, Tochigi-ken (JP); Yasuhisa Saito, Tochigi-ken (JP); Shinyu Hirayama, Tochigi-ken (JP); Hironori Sawamura, Tochigi-ken (JP); Shogo Nagayoshi, Tochigi-ken (JP); Xihao Tan, Tochigi-ken (JP); Sumitomo Watanabe, Tochigi-ken (JP); Takahiro Morita, Tochigi-ken (JP)

(21) Appl. No.: 16/125,822

(22) Filed: Sep. 10, 2018

(30) Foreign Application Priority Data
Sep. 13, 2017 (JP) 2017-175321

(51) Int. Cl. B23K 11/11; B23K 11/24; B23K 11/36

(52) U.S. Cl. CPC B23K 11/115; B23K 11/364; B23K 11/241

(57) ABSTRACT

A resistance welding method according to the present invention includes a current control step of sequentially performing a first control for maintaining a welding current being a direct current at a current value I1 (first target value) or in the vicinity of the current value I1, a second control for raising the welding current from the current value I1 to a current value I2 (second target value, I2>I1) and for subsequently maintaining the welding current at the current value I2 or in the vicinity of the current value I2, and a third control for lowering the welding current from the current value I2 to a value smaller than the current value I1, and the resistance welding method further comprises an energization step of applying the welding current while repeating the current control step plural times until a predetermined energization period of time elapses.

### CROSS-REFERENCE TO RELATED APPLICATION

This application is based upon and claims the benefit of priority from Japanese Patent Application No. 2017-175321 filed on Sep. 13, 2017, the contents of which are incorporated herein by reference.

### BACKGROUND OF THE INVENTION

### Field of the Invention

The present invention relates to a resistance welding method and a resistance welding apparatus for performing a spot joining on a workpiece composed of a plurality of overlapped plate materials by clamping and pressing the workpiece with a pair of electrodes and then by applying a welding current between the pair of electrodes.

### Description of the Related Art

Heretofore, there has been known a resistance welding technology for performing a spot joining on a workpiece composed of a plurality of overlapped plate materials by clamping and pressing the workpiece with a pair of electrodes and then by applying a welding current between the pair of electrodes. For example, there has been proposed a current control method for suppressing generation of spatters (hereafter, also referred to as dust) by improving the affinity between the contact faces of steel plates.

Japanese Laid-Open Patent Publication No. 2003-236674 proposes a current control method for spot-welding high-tensile steel plates by giving a temporal pausing after a preliminary energization and then by performing a main energization.

Japanese Laid-Open Patent Publication No. 2010-207909 proposes a current control method for spot-welding high-tensile steel plates by temporarily lowering the current value after a preliminary energization and then by performing a main energization.

### SUMMARY OF THE INVENTION

However, because in the methods proposed in Japanese Laid-Open Patent Publication No. 2003-236674 and Japanese Laid-Open Patent Publication No. 2010-207909, it is necessary to set respective control conditions for the preliminary energization and the main energization, and thus, a problem arises in that it is difficult to make an optimizing design that combines two different sets of control conditions.

In order to solve the aforementioned problem, it is an object of the present invention to provide a resistance welding method and a resistance welding apparatus capable of suppressing generation of spatters while performing a relatively simple current control.

A resistance welding method according to a first aspect of the present invention is a method for performing a spot joining on a workpiece composed of a plurality of overlapped plate materials by clamping and pressing the workpiece with a pair of electrodes and then by applying a welding current between the pair of electrodes. The resistance welding method includes a current control step of sequentially performing a first control for maintaining the welding current being a direct current at a first target value or in a vicinity of the first target value, a second control for raising the welding current from the first target value to a second target value being larger than the first target value and for subsequently maintaining the welding current at the second target value or in a vicinity of the second target value, and a third control for lowering the welding current from the second target value to a value being smaller than the first target value, and the method further includes an energization step of applying the welding current while repeating the current control step plural times until a predetermined energization period of time elapses.

Like this, by performing the first control and the second control for raising the welding current stepwise at two stages of the first target value and the second target value, the heat quantity given to a joining portion of the workpiece becomes flexibly adjustable, and excessive growth of a nugget is suppressed in comparison with the case that the welding current is raised rapidly. Further, by performing the third control for lowering the welding current from the second target value to a value smaller than the first target value, it is possible to secure a heat radiation period of time during which Joule heat concentrating on a boundary portion of the nugget is radiated outside the nugget.

Because the welding current is applied while the aforementioned current control step is repeated plural times, the heat input to the workpiece is performed intermittently. That is, the gradual growth of the nugget makes it possible to secure a greater seal width than that in the case of a continuous heat input, and this makes spatters less likely to be generated. Thus, it is possible to suppress generation of spatters in spite of the execution of a relatively simple current control.

Further, the first target value and the second target value may be determined in dependence on two adjoining plate materials whose resistance values at a joining portion provide a largest sum among three or more plate materials composing the workpiece. Thus, it is possible to perform an appropriate current control for the two plate materials which generate the largest heat quantity because the sum of the resistance values is largest, that is, for the two plate materials which are most likely to generate spatters.

Now, let a limit current value be defined as an upper limit value of electric current until which spatters are not generated at a welded portion between the two plate materials when a constant direct current is applied to the workpiece for the energization period of time. In this case, the first target value may be smaller than the limit current value, and the second target value may be larger than the limit current value. Thus, it is possible to effectively apply Joule heat to another welded portion while generation of spatters is reliably suppressed between the aforementioned two plate materials, and hence, it is possible to secure weld strength of the workpiece.

Further, at the energization step, the welding current may be applied while a pressing force on the workpiece is kept fixed. Thus, it is not required to perform a complicated control such as changing the pressing force with the lapse of time.

Further, the workpiece may be composed to include at least one high-tensile plate material. The workpiece including the high-tensile plate material tends to generate spatters and has a high degree of difficulty in current control. Making the nugget grow gradually is particularly effective because a larger seal width can be secured.

A resistance welding apparatus according to a second aspect of the present invention is an apparatus configured to perform a spot joining on a workpiece composed of a plurality of overlapped plate materials by clamping and pressing the workpiece with a pair of electrodes and then by applying a welding current between the pair of electrodes. The resistance welding apparatus includes a welding current generating circuit configured to apply the welding current and a welding current control unit configured to control the welding current generating circuit to execute a current control which sequentially performs a first control for maintaining the welding current being a direct current at a first target value or in a vicinity of the first target value, a second control for raising the welding current from the first target value to a second target value being larger than the first target value and for subsequently maintaining the welding current at the second target value or in a vicinity of the second target value, and a third control for lowering the welding current from the second target value to a value being smaller than the first target value, wherein the welding current control unit is further configured to repeat the current control plural times until a predetermined energization period of time elapses.

According to the resistance welding method and the resistance welding apparatus in the present invention, it is possible to suppress generation of spatters by performing a relatively simple current control.

The above and other objects, features, and advantages of the present invention will become more apparent from the following description when taken in conjunction with the accompanying drawings in which a preferred embodiment of the present invention is shown by way of an illustrative example.

### BRIEF DESCRIPTION OF THE DRAWINGS

FIG. 1 is an entire configuration diagram of a resistance welding apparatus according to one embodiment of the present invention;

FIG. 2A is a schematic sectional view showing the welded state of a workpiece composed of three overlapped plate materials;

FIG. 2B is a schematic sectional view showing the welded state of a workpiece composed of four overlapped plate materials;

FIG. 3A is a graph showing one example of a current pattern corresponding to one cyclic period of welding current;

FIG. 3B is a graph showing one example of a command pattern for realizing the current pattern shown in FIG. 3A;

FIG. 4A is a graph showing a current pattern used in performing a spot welding;

FIG. 4B is a graph showing a time-dependent change of a chip-to-chip voltage when the current pattern shown in FIG. 4A is applied;

FIG. 5A is a photograph showing an enlarged section of a welded state of the workpiece in a conventional example (DC constant);

FIG. 5B is a photograph showing an enlarged section of another welded state of the workpiece in the conventional example (DC constant);

FIG. 6A is a photograph showing an enlarged section of a welded state of the workpiece in the present embodiment (DC chop);

FIG. 6B is a photograph showing an enlarged section of another welded state of the workpiece in the present embodiment (DC chop);

FIG. 7 is a graph showing a relationship between seal width and energization period of time;

FIG. 8A is a graph showing a command pattern in a modification; and

FIG. 8B is a graph showing another command pattern in the modification.

### DESCRIPTION OF THE PREFERRED EMBODIMENTS

Hereafter, with reference to the accompanying drawings, a resistance welding method according to the present invention will be described in detail based on an embodiment preferred in connection with a resistance welding apparatus.

### [Configuration of Resistance Welding Apparatus 10]

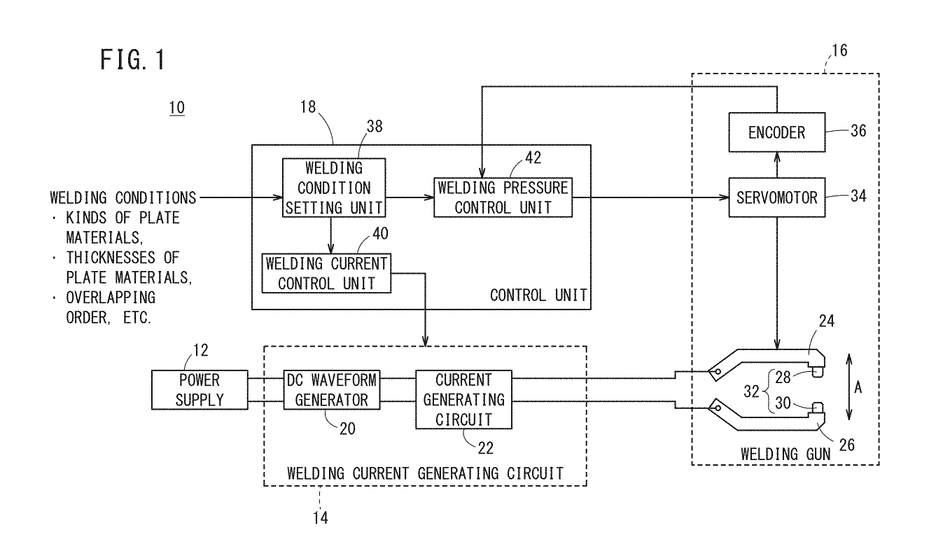

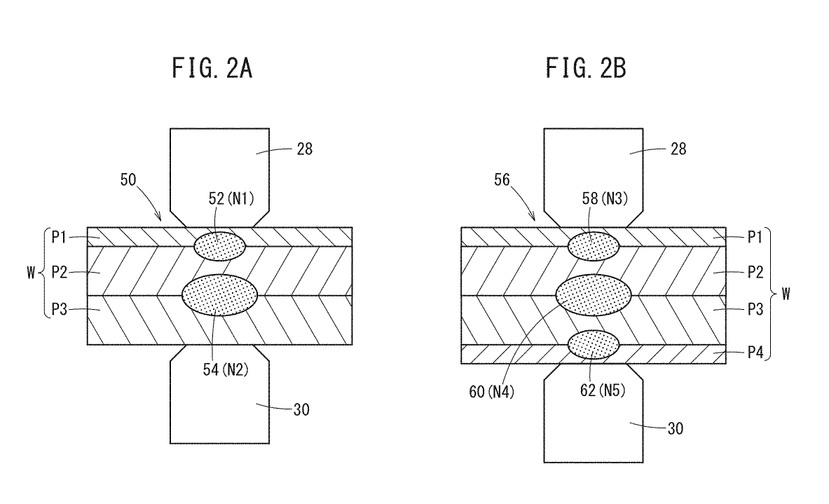

FIG. 1 is an entire configuration diagram of a resistance welding apparatus 10 according to one embodiment of the present invention. The resistance welding apparatus 10 includes a welding current generating circuit 14 configured to output a welding current based on electric power supplied from a power supply 12, a welding gun 16 configured to perform a spot welding while clamping and pressing a workpiece W (FIG. 2A and FIG. 2B), and a control unit 18 configured to synchronously control the welding current generating circuit 14 and the welding gun 16.

The welding current generating circuit 14 is provided with a DC (direct current) waveform generator 20 configured to generate a DC waveform based on AC (alternating current) power or DC power from the power supply 12 and a current generating circuit 22 configured to output a desired welding current by chopping the DC waveform.

The welding gun 16 is equipped with a movable arm 24 and a fixed arm 26 configured to clamp the workpiece W, electrode chips 28, 30 (hereafter also referred to as a pair of electrodes 32) respectively attached to the movable arm 24 and the fixed arm 26, and a servomotor 34 capable of moving the movable arm 24 in a direction (the arrow A direction) to clamp the workpiece W.

The movable arm 24 is connected to a displacement mechanism (for example, a ball screw, not shown). Since the displacement mechanism is pivoted by the servomotor 34, the movable arm 24 comes close to or away from the fixed arm 26. Thus, it is possible to press the workpiece W under a desired welding pressure. An encoder 36 is a sensor capable of detecting the displacement amount of the movable arm 24 and outputs the acquired detection signal to the control unit 18.

The control unit 18 is constituted by a CPU (Central Processing Unit) or an MPU (Micro-Processing Unit). The control unit 18 operates as a welding condition setting unit 38, a welding current control unit 40 and a welding pressure control unit 42 by reading and executing a program from a ROM (Read Only Memory, not shown).

The welding condition setting unit 38 sets welding conditions appropriate to the configuration of the workpiece W to be welded. In accordance with input operations by the worker for example, the welding condition setting unit 38 is able to set “direct” parameters including current values, energization periods of time and the number of repetitions in addition to “indirect” parameters including the kinds, thicknesses and overlapped order of plate materials P1-P4.

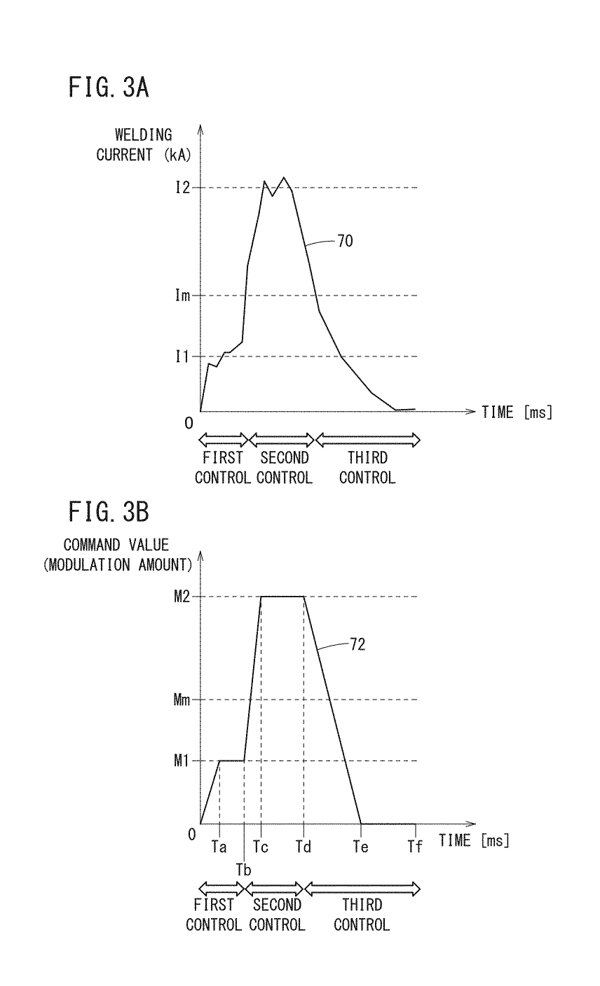

The welding current control unit 40 controls the welding current that the welding current generating circuit 14 outputs, in accordance with the welding conditions set by the welding condition setting unit 38. Specifically, the welding current control unit 40 generates a command pattern 72 (FIG. 3B) being appropriate to the configuration of the workpiece W and then supplies the command pattern 72 to the welding current generating circuit 14. Thus, the welding current generating circuit 14 outputs a welding current that repeats a current pattern 70 (FIG. 3A) plural times.

The welding pressure control unit 42 controls the welding pressure at which the pair of electrodes 32 clamp the workpiece W, in accordance with the welding conditions set by the welding condition setting unit 38. During the energization of the welding current, the welding pressure control unit 42 may fix the welding pressure regardless of time or may change the welding pressure in dependence on time.

### [Welded State of Workpiece W]

FIG. 2A is a schematic sectional view showing the welded state of a workpiece W composed of three overlapped plate materials P1-P3. FIG. 2B is a schematic sectional view showing the welded state of a workpiece W composed of four overlapped plate materials P1-P4. The plate materials P1-P4 are all metal plates and may include at least one high-tensile plate material (High-tensile material).

In FIG. 2A, when the welding current is applied between the electrode chips 28, 30 with a joining portion 50 of the workpiece W clamped and pressed, Joule heat is generated at the joining portion 50. Thus, a nugget N1 is formed at a welded portion 52 between the adjoining plate materials P1, P2, and a nugget N2 is formed at a welded portion 54 between the adjoining plate materials P2, P3.

In FIG. 2B, when the welding current is applied between the electrode chips 28, 30 with a joining portion 56 of the workpiece W clamped and pressed, Joule heat is generated at the joining portion 56. Thus, a nugget N3 is formed at a welded portion 58 between the adjoining plate materials P1, P2, a nugget N4 is formed at a welded portion 60 between the adjoining plate materials P2, P3, and a nugget N5 is formed at a welded portion 62 between the adjoining plate materials P3, P4.

Here, electrical resistance values (hereafter referred to simply as “resistance values”) of the plate materials P1, P2, P3, P4 are assumed as R1, R2, R3, R4 respectively. The resistance values R1-R4 are each not the entire resistance value of each of the plate materials, but correspond to respective values which are each calculated by multiplying a unit area resistivity by the thickness of the joining portion 50 (56) in each of the plate materials P1-P4.

The sum of the resistance values of the adjoining plate materials P1, P2 is Rs12 (=R1+R2). The sum of the resistance values of the adjoining plate materials P2, P3 is Rs23 (=R2+R3). The sum of the resistance values of the adjoining plate materials P3, P4 is Rs34 (=R3+R4). For example, it is now assumed that the sum Rs23 is largest of the three kinds of sums (Rs12, Rs23, Rs34).

### [Operation of Resistance Welding Apparatus 10]

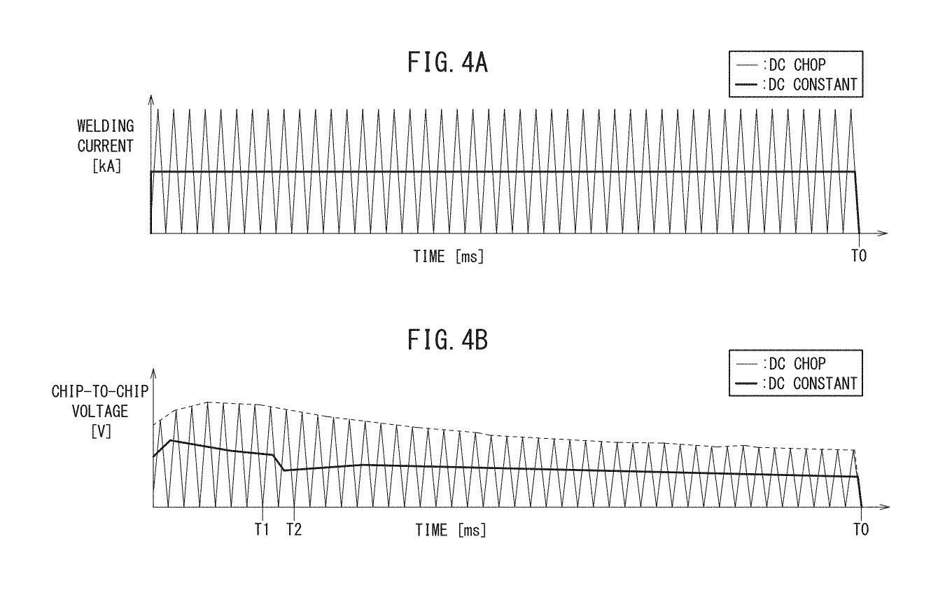

Next, the operation of the resistance welding apparatus 10 shown in FIG. 1 will be described with reference to FIG. 3A through FIG. 4B. Under the synchronous control of the control unit 18, the resistance welding apparatus 10 clamps and presses the workpiece W at a predetermined welding pressure and then applies a predetermined welding current between the pair of electrodes 32. Thus, a spot welding is performed on the workpiece W.

Here, because the welding pressure control unit 42 executes a control under which the welding current is applied with the pressing force on the workpiece W kept constant, it is not required to perform such a complicated control as to change the welding pressure with time. On the other hand, the welding current control unit 40 executes such a control that a series of current controls each taking one cycle in the order of about 10 ms are repeated in the order of 10 to 100 times.

### <Specific Example of Current Control>

FIG. 3A is a graph showing one example of the current pattern 70 corresponding to one cyclic period of the welding current. The horizontal axis of the graph represents time (unit: ms), and the vertical axis of the graph represents welding current (unit: kA). The current pattern 70 is formed by a series of current controls (first to third controls) performed by the welding current control unit 40 (FIG. 1).

The first control is a current control for raising the welding current as the control object to a current value I1 (first target value) and for subsequently maintaining the welding current at the current value I1 or in the vicinity of the same. The second control is a current control for raising the welding current as the control object from the current value I1 to a current value I2 (second target value, I2>I1) and for subsequently maintaining the welding current at the current value I2 or in the vicinity of the same. The third control is a current control for lowering the welding current as the control object from the current value I2 to a value smaller than the current value I1 (substantially to a zero value).

Like this, by executing the first control and the second control that stepwise raise the welding current at separate two stages of the current values I1 and I2, it becomes possible to flexibly adjust the heat quantity given to the joining portion 50 (56) of the workpiece W. As a result, excessive growths of the nuggets N1-N5 are suppressed in comparison with the case that the welding current is raised rapidly. Further, by executing the third control that lowers the welding current from the current value I2 to a value smaller than the current value I1, it is possible to secure a heat radiation period of time during which the Joule heat concentrating on the boundary portions of the nuggets N1-N5 is radiated outside the nuggets N1-N5.

FIG. 3B is a graph showing one example of the command pattern 72 for realizing the current pattern 70 shown in FIG. 3A. The horizontal axis of the graph represents time (unit: ms), and the vertical axis of the graph represents command value (unit: arbitrary). For example, the command value is a modulation amount in a pulse modulation and has a relationship that the effective value of the welding current increases as the value increases.

The command value in a time zone t=0−Ta is linearly increased in proportion to the lapse of time and becomes equal to a command value M1 at time t=Ta. The command value in a time zone t=Ta−Tb is constant (the command value M1) regardless of time. Here, the command value M1 is a value corresponding to the current value I1 (FIG. 3A).

The command value in a time zone t=Tb−Tc is linearly increased in proportion to the lapse of time and becomes equal to a command value M2 (>M1) at time t=Tc. The command value in a time zone t=Tc−Td is constant (the command value M2) regardless of time. Here, the command value M2 is a value corresponding to the current value I2 (FIG. 3A).

The command value in a time zone t=Td−Te is linearly decreased in proportion to the lapse of time and becomes equal to the zero value at time t=Te. The command value in a time zone t=Te−Tf is constant (zero value) regardless of time.

Incidentally, other than being specified by the command values M1, M2 (or current values I1, I2), the current pattern 70 is specified by parameters including a first start-up period of time (Ta), a first duration (Tb−Ta), a second start-up period of time (Tc−Tb), a second duration (Td−Tc), a fall period of time (Te−Td) and an off period of time (Tf−Te). These parameters may take arbitrary values.

Further, the welding current control unit 40 may determine the current values I1, I2 being appropriate to the configuration of the workpiece W. For example, the current values I1, I2 are determined in dependence on the two plate materials P2, P3 whose aforementioned resistance values provide the largest sum (Rs23). Specifically, a limit current value Im is defined as an upper limit value of the current until which spatters are not generated at the welded portion 54 (60) between the two plate materials P2, P3 when a constant direct current is applied to the workpiece W for an energization period of time. In this case, the current values I1, I2 are determined so as to satisfy the magnitude relationship of I1<Im<I2.

### <Description of Energization Pattern>

FIG. 4A is a graph showing a current pattern used in performing a spot welding. The horizontal axis of the graph represents time (unit: ms), and the vertical axis of the graph represents welding current (unit: kA). “DC chop (present embodiment)” represented by a thin solid line corresponds to the energization pattern made by the repetition of the current pattern 70 (FIG. 3A) through plural times. “DC constant (conventional example)” represented by the thick solid line corresponds to an energization pattern in which a constant direct current is applied.

Here, the “DC chop” and the “DC constant” have the same energization period of time (=T0). Further, the current value of the “DC constant” corresponds to a value (that is, an effective current value) such that the heat quantities given to the workpiece W in accordance with the both energization patterns become equal.

FIG. 4B is a graph showing a time-dependant change of a chip-to-chip voltage when the current pattern shown in FIG. 4A is given. The horizontal axis of the graph represents time (unit: ms), and the vertical axis of the graph represents the chip-to-chip voltage (unit: V). Incidentally, the chip-to-chip voltage corresponds to the voltage between the electrode chips 28, 30 (FIGS. 2A and 2B).

Similarly to FIG. 4A, the thin solid line represents a voltage waveform of the “DC chop”, and the thick solid line represents a voltage waveform of the “DC constant”. The graph shown by the broken line represents an upper-side envelope in the voltage waveform of the “DC chop”. Here, the graph of the “DC constant” shows that the chip-to-chip voltage in the time zone T1-T2 suddenly drops and spatters occur.

### [Effects of Resistance Welding Method]

### <Mechanism to Suppress Spatters>

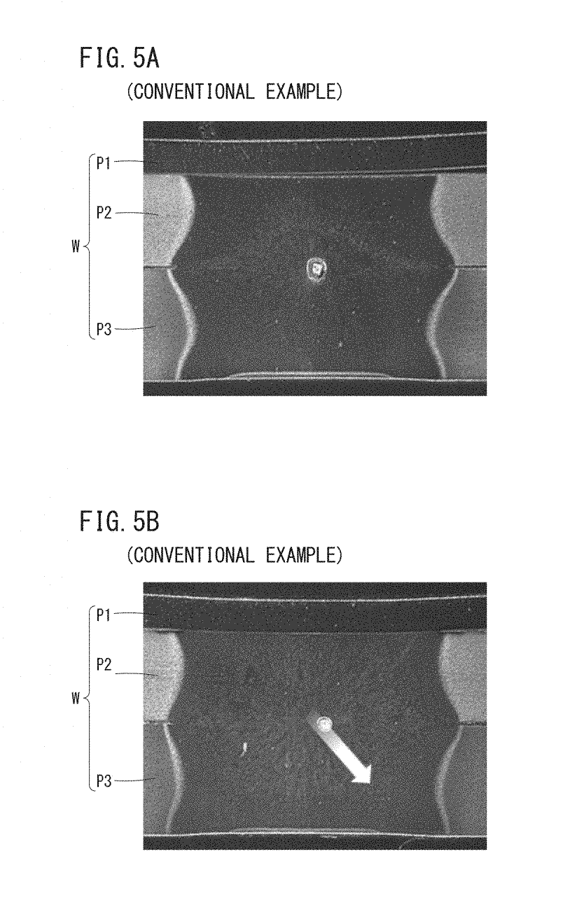

Next, a mechanism to suppress spatters by the current control of the “DC chop” will be described with reference to FIGS. 5A through 7.

FIGS. 5A and 5B are photographs each showing an enlarged section of a welded state of the workpiece W in the conventional example (DC constant). More specifically, FIG. 5A shows the welded state at the time T1 (FIG. 4B), while FIG. 5B shows the welded state at the time T2 (FIG. 4B).

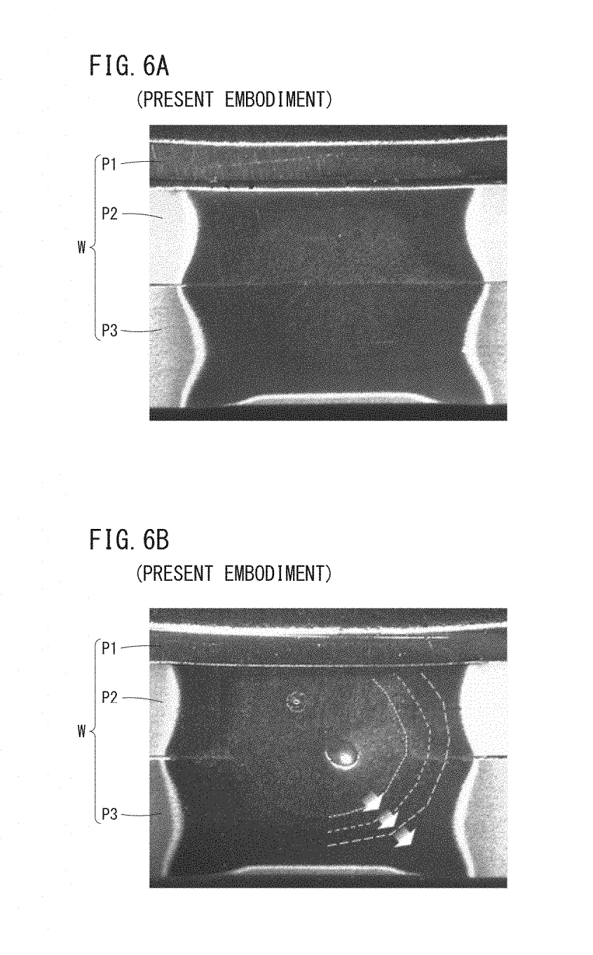

FIG. 6A and FIG. 6B are photographs each showing an enlarged section of a welded state of the workpiece W in the present embodiment (DC chop). More specifically, FIG. 6A shows the welded state at the time T1, while FIG. 6B shows the welded state at the time T2.

As understood from FIG. 5B, continuous input of heat to the workpiece W is performed by the continuous application of the constant direct current. As a result, melting occurs at a relatively early stage, and this creates “continuous melting marks” showing the state that Joule heat always concentrates on the boundary portion of each of the nuggets N1-N5.

On the other hand, as understood from FIG. 6B, intermittent input of heat to the workpiece W is performed by the repetitive energization in the current pattern 70 (FIG. 3A). As a result, melting occurs at a relatively late stage, and this creates “intermittent melting marks” showing the state that solidification and remelting are repeated at the boundary portion of each of the nuggets N1-N5.

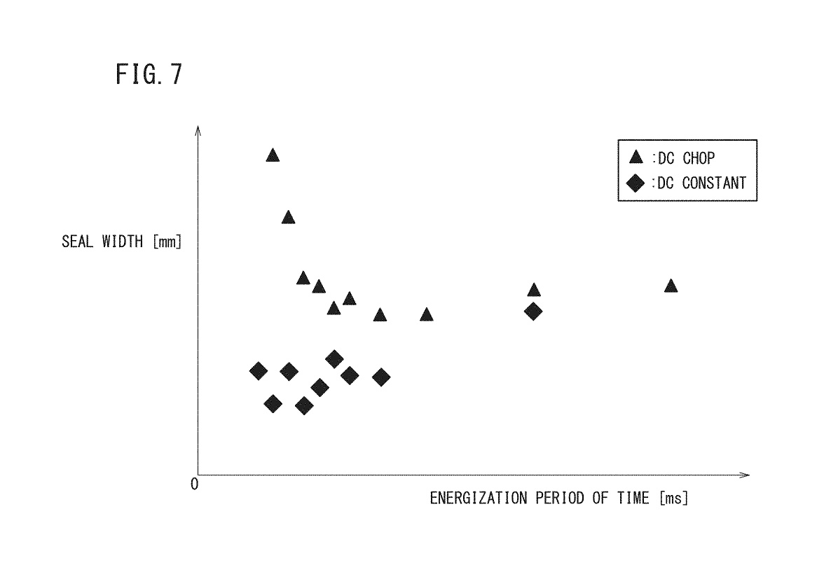

FIG. 7 is a graph showing a relationship between seal width and energization period of time. The horizontal axis of the graph represents energization period of time (unit: ms), and the vertical axis of the graph represents seal width (unit: mm). This “seal width” is defined as a value obtained by subtracting a nugget diameter from the seal diameter (corresponding to the corona bond diameter). That is, a state that spatters are likely to be generated arises when the seal width becomes smaller, while another state that spatters are less likely to be generated arises when the seal width becomes larger.

Triangle marks show measured data of the “DC chop” (present embodiment), and diamond marks show measured data of the “DC constant” (conventional example). As understood from this graph, it can be said that when the nuggets N1-N5 are in the course of growth and the time from the starting of energization is short, the seal width of the “DC chop” is significantly large in comparison with that of the “DC constant”.

### <Summary of Effects>

As described above, this resistance welding method is a method for performing a spot joining on the workpiece W composed of the plurality of overlapped plate materials P1-P4 by clamping and pressing the workpiece W with the pair of electrodes 32 and then by applying a welding current between the pair of electrodes 32. The resistance welding method comprises [1] the current control step of sequentially performing the first control for maintaining the welding current being a direct current at the current value I1 (first target value) or in the vicinity of the current value I1, the second control for raising the welding current from the current value I1 to the current value I2 (second target value, I2>I1) and for subsequently maintaining the welding current at the current value I2 or in the vicinity of the current value I2, and the third control for lowering the welding current from the current value I2 to a value smaller than the current value I1, and the method further comprises [2] the energization step of applying the welding current while repeating the current control step plural times until a predetermined energization period of time elapses.

Further, this resistance welding apparatus 10 is an apparatus configured to perform a spot joining on the workpiece W composed of the plurality of overlapped plate materials P1-P4 by clamping and pressing the workpiece W with the pair of electrodes 32 and then by applying a welding current between the pair of electrodes 32. The resistance welding apparatus comprises [1] the welding current generating circuit 14 configured to apply the welding current and [2] the welding current control unit 40 configured to control the welding current generating circuit 14 to execute the current control which sequentially performs the first control for maintaining the welding current being a direct current at the current value I1 (first target value) or in the vicinity of the current value I1, the second control for raising the welding current from the current value I1 to the current value I2 (second target value, I2>I1) and for subsequently maintaining the welding current at the current value I2 or in the vicinity of the current value I2, and the third control for lowering the welding current from the current value I2 to a value smaller than the current value I1, wherein the welding current control unit 40 is further configured to repeat the current control plural times until a predetermined energization period of time elapses.

Like this, by performing the first and second controls which stepwise raise the welding current to the current value I1 and the current value I2 through two stages, it is possible to flexibly adjust the heat quantity given to the joining portion 50 (56) of the workpiece W, whereby excessive growths of the nuggets N1-N5 can be suppressed in comparison with the case where the welding current is raised rapidly. Further, by performing the third control for lowering the welding current from the current value I2 to the value smaller than the current value I1, it is possible to secure a heat radiation period of time during which Joule heat concentrating on the boundary portions of the nuggets N1-N5 is radiated outside the nuggets N1-N5.

Further, by applying the welding current while repeating the aforementioned current control step plural times, the intermittent input of heat is performed to the workpiece W. That is, by making the nuggets N1-N5 grow gradually, it is possible to secure greater seal widths in comparison with the case that the input of heat is performed continuously, and this makes spatters less likely to be generated. Thus, it is possible to suppress the generation of spatters in spite of the execution of the relatively simple current control.

Further, the current values I1, I2 may be determined based on the two adjoining plate materials P2, P3, whose resistance values at the joining portion 50 (56) provide the largest sum, of the three or more plate materials P1-P4 composing the workpiece W. Thus, it is possible to execute the current control appropriate to the two plate materials P2, P3 whose resistance values provide the largest sum and which generate the largest heat quantity, that is, appropriate to the two plate materials P2, P3 in which spatters are most likely to be generated.

Further, assuming that the limit current value Im is defined as the upper limit of electric current until which spatters are not generated at the welded portion 54 (60) between the two plate materials P2, P3 when a constant direct current is applied to the workpiece W for the energization period of time, the current values I1, I2 may be determined to satisfy the magnitude relationship of I1<Im<I2. Thus, it is possible to effectively apply Joule heat to other welded portions 52 (58, 62) while reliably suppressing the generation of spatters between the two plate materials P2, P3, and hence, it is possible to secure the weld strength of the workpiece W.

Furthermore, the workpiece W may be composed to include at least one high-tensile plate material. The workpiece W including a high-tensile plate material tends to suffer spatters and has a high degree of difficulty in current control. Making the nuggets N1-N5 grow gradually is particularly effective because a larger seal width can be secured.

### [Modifications]

Incidentally, the present invention is not limited to the above-described embodiment and can of course be freely modified without departing from the gist of the present invention. Alternatively, the various configurations may be arbitrarily combined within an extent in which inconsistency does not arise technically.

Although in the present embodiment, the welding current control unit 40 carries out the current control in accordance with the command pattern 72 shown in FIG. 3B, the form of the command pattern is not limited to this pattern.

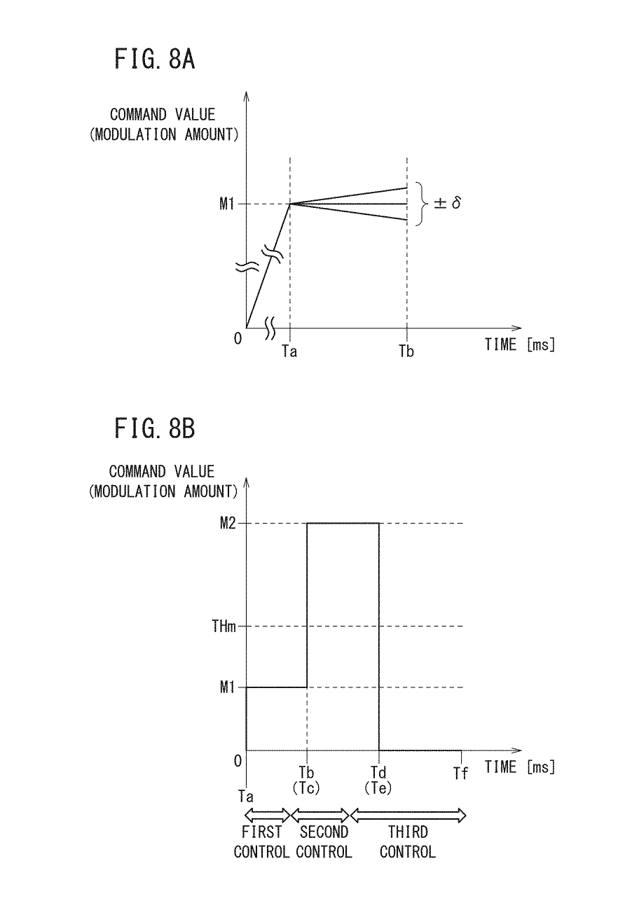

As shown in FIG. 8A, the command value in the time zone Ta−Tb may be slightly varied as time passes. For example, the command value may be increased or decreased, or varied, within a tolerable range (within M1±δ, where δ is a minute positive value) relative to the command value. Also in accordance with a command pattern modified like this, it is possible to realize the first control that maintains the welding current in the vicinity of the current value I1. Incidentally, the same is true of the second control which maintains the welding current in the vicinity of the current value I2.

As shown in FIG. 8B, it is possible to rapidly shift the command value from zero value to the M1 at time t=0 (=Ta), to rapidly shift the command value from the M1 to the M2 at time t=Tb (=Tc), and to rapidly shift the command value from the M2 to zero value at time t=Td (=Te). By the use of this command pattern, it is also possible to execute the current control which is able to realize the above-described operational effects.

What is claimed is:

1. A resistance welding method for performing a spot joining on a workpiece composed of a plurality of overlapped plate materials by clamping and pressing the workpiece with a pair of electrodes and then by applying a welding current between the pair of electrodes, the method comprising:
a current control step of sequentially performing:
a first control for maintaining the welding current being a direct current at a first target value or in a vicinity of the first targeted value;
a second control for raising the welding current from the first target value to a second target value being larger than the first target value and for subsequently maintaining the welding current at the second target value or in a vicinity of the second target value; and
a third control for lowering the welding current from the second target value to a value being smaller than the first target value; and
an energization step of applying the welding current while repeating the current control step plural times until a predetermined energization period of time elapses.

2. The resistance welding method according to claim 1, wherein:
the first target value and the second target value are determined in dependence on two adjoining plate materials whose resistance values at a joining portion provide a largest sum among three or more plate materials composing the workpiece.

3. The resistance welding method according to claim 2, wherein:
assuming that a limit current value is defined as an upper limit value of electric current until which spatters are not generated at a welded portion of the two plate materials when a constant direct current is applied to the workpiece for the energization period of time;
the first target value is smaller than the limit current value, and the second target value is larger than the limit current value.

4. The resistance welding method according to claim 1, wherein, at the energization step, the welding current is applied with a pressing force on the workpiece maintained constant.

5. The resistance welding method according to claim 1, wherein the workpiece is composed to include at least one high-tensile plate material.

6. A resistance welding apparatus configured to perform a spot joining on a workpiece composed of a plurality of overlapped plate materials by clamping and pressing the workpiece with a pair of electrodes and then by applying a welding current between the pair of electrodes, the apparatus comprising:
a welding current generating circuit configured to apply the welding current; and
a welding current control unit configured to control the welding current generating circuit to execute a current control which sequentially performs:
a first control for maintaining the welding current being a direct current at a first target value or in a vicinity of the first target value;
a second control for raising the welding current from the first target value to a second target value being larger than the first target value and for subsequently maintaining the welding current at the second target value or in a vicinity of the second target value; and
a third control for lowering the welding current from the second target value to a value being smaller than the first target value;
wherein the welding current control unit is further configured to repeat the current control plural times until a predetermined energization period of time elapses.
